(19) United States
(12) Patent Application Publication
(10) Pub. No.: US 2008/0151143 A1
(43) Pub. Date: Jun. 26, 2008

(54) Light emitting diode based backlighting for color liquid crystal displays

(75) Inventors: Yi-Qun Li, Danville, CA (US); Gordon Liu, Fremont, CA (US); Yi Dong, Tracy, CA (US)

Correspondence Address: BUCHANAN, INGERSOLL & ROONEY PC, POST OFFICE BOX 1404, ALEXANDRIA, VA, 22313-1404, US

(73) Assignee: Intematix Corporation, Fremont, CA (US)

(21) Appl. No.: 11/974,927

(22) Filed: Oct. 15, 2007

Related U.S. Application Data
(60) Provisional application No. 60/853,399, filed on Oct. 19, 2006.

(51) Int. Cl. G02F 1/13357; H05B 33/00

(52) U.S. Cl. 349/68; 313/503

(57) ABSTRACT

A liquid crystal display backlight comprises: at least one blue light emitting diode (LED) operable to contribute blue light to white light generated by the backlight; a phosphor material which absorbs a portion of the blue light and emits green light which contributes green light to the white light generated by the backlight; and at least one red LED operable to contribute red light to the white light generated by the backlight. In one arrangement the red LED is replaced with a second phosphor material which absorbs a portion of the blue light and emits red light which contributes to the white light generated by the backlight. Many packaging configurations are possible.

### CROSS REFERENCE TO RELATED APPLICATION

This Application claims the benefit of priority from U.S. Provisional Application No. 60/853,399 filed Oct. 19, 2006, the specification and drawings of which is incorporated herein by reference.

### BACKGROUND OF THE INVENTION

1. Field of the Invention

The present invention relates to color, transmissive liquid crystal displays (LCDs). More particularly the invention concerns backlighting systems for such displays which are based on light emitting diodes (LEDs).

2. Description of the Related Art

Color LCDs are based on picture elements, or “pixels”, formed by a matrix/array of liquid crystal (LC) cells. As is known the intensity of the light passing through a LC can be controlled by changing the angle of polarization of the light in response to an electrical field, voltage, applied across the LC. For a color LCD each pixel is actually composed of three “sub-pixels”: one red (R), one green (G), and one blue (B). Taken together, this sub-pixel triplet makes up what is referred to as a single pixel. What the human eye perceives as a single white pixel is actually a triplet of RGB sub-pixels with weighted intensities such that each of the three sub-pixels appears to have the same brightness.

The principle of operation of a color, transmissive LCD is based upon a bright white light backlighting source located behind the liquid crystal (LC) matrix, and a panel of color filters positioned on an opposite side of the liquid crystal matrix. The liquid crystal matrix is switched to adjust the intensity of the white light from the backlighting source reaching each of the color filters of each pixel, thereby controlling the amount of colored light transmitted by the RGB sub-pixels. Light exiting the color filters generates the color image.

A typical LCD structure is sandwich-like in which the liquid crystal 10 is provided between two glass panels 12, 14; one glass panel 12 containing the switching elements 16 that control the voltage being applied across electrodes of the LC corresponding to respective sub-pixel 18, and the other glass panel 14 containing the color filters 20. The switching elements 16 for controlling the LC matrix which are located on the back of the structure, that is facing the backlighting source 22, typically comprise an array of thin film transistors (TFTs) in which a respective TFT is provided for each sub-pixel. The color filter glass panel 20 has a set of primary (red, green, and blue) color filters grouped together. Light exits the color filter glass panel to form the image.

As is known LCs have the property of rotating the plane of polarization of light as a function of the applied electric field, voltage. Through the use of crossed polarizing filters 24, 26 and by controlling the degree of rotation of the polarization of the light as a function of the voltage applied across the LC the amount of white light supplied by the backlighting source 22 to the filters is controlled for each red, green and blue sub-pixel. The light transmitted through the filters generates a range of colors for producing images that viewers see on a TV screen or computer monitor. LCD color performance is a key parameter and depends on two factors: the quality of the RGB filter array and the quality of the white light used to backlight the display.

Traditionally, color LCDs have been backlit using cold cathode fluorescent lamps (CCFLs). However, the recent development of light emitting diodes (LEDs) has enabled these types of devices to be used increasingly as the lighting source referred to as “backlight unit” (BLU). Most commonly, LED light sources in BLUs involve either (i) white LEDs in which a blue emitting LED chip excites a yellow emitting phosphor (photo-luminescent) material or (ii) separate red (R), green (G) and blue (B) direct light generating LEDs (that is, an LED containing no phosphor material to convert the wavelength of generated light). To achieve white balance, two green LEDs and/or LED chips are necessary in practice when using the RGB LED approach because of the higher proportion of green light in the visible spectrum (typically greater than about 59%). This results in what is in reality an RGGB configuration.

Typical emission spectra (intensity versus wavelength) for backlighting units based on cold cathode fluorescent lamps (CCFLs), white LEDs and RGB LEDs are shown in FIGS. 2a to 2c respectively. FIG. 3 is a CIE (Commission Internationale de l'Eclairage) 1931 chromaticity diagram illustrating the NTSC (National Television Standards Committee) color space specification and color space for backlighting systems based on (a) CCFLs, (b) white LED and (c) RGB LEDs. The nature of the backlights' emission spectrum dictates that, typically, CCFL achieves around 70% of the NTSC Specification, while white LEDs and RGB LEDs achieve around 40% and 105% of NTSC, respectively.

The trend of replacing CCFLs with LED based backlighting is driven by the fact CCFLs suffers from a number of disadvantages including reduced color performance (70% NTSC), large size relative to volume of the device, and the high cost of associated hardware, such as expensive drive circuits, etc.

An advantage of white LED backlighting systems is that since they are relatively simple in design they are accordingly relatively inexpensive to produce and as a consequence are mostly used in low-end displays, such as cell phones, where their lower color performance (about 40% of the NTSC specification) is acceptable.

RGB LED backlights offer advantages due to the heightened freedom they allow pertaining to color choices and the color specification. The color performance of an RGB LED backlighting system can exceed the requirements of NTSC. However, such systems suffer from a number of drawbacks, including variation and unevenness of luminance and color. These systems also require special consideration to attain the desired color mixing, intensity variation, and thermal stability, with a subsequently complicated sensor and feedback loop necessary for monitoring the color from each of the component LEDs. To date, RGB LED backlighting systems are limited to a relatively small number of high-end applications.

What is needed in the art, therefore, is a low cost backlighting system which can provide a white light which closer achieves the NTSC defined specification.

### SUMMARY OF THE INVENTION

The present invention arose in an endeavor to provide an LED-based backlight for a color emissive LCD which, at least in part, is an improvement on the known backlighting systems. Embodiments of the present invention are directed to an LED based backlight system for providing white light to a liquid crystal display (LCD). In contrast to the prior art backlighting systems, which use three different types of LEDs (red, green and blue), the present embodiments are directed to a system using only one or two types of LEDs (blue only or red and blue). In each case a green phosphor (photo-luminescent) material is excited by the blue LED to generate green light that combines with the blue and red light to make a white backlighting light.

According to the invention a liquid crystal display backlight comprises: at least one blue light emitting diode (such as an InGaN/GaN (indium gallium nitride/gallium nitride) based LED chip) operable to contribute blue light to white light generated by the backlight; a phosphor material which absorbs a portion of the blue light and emits green light which contributes to the white light generated by the backlight; and at least one red light emitting diode operable to contribute red light to the white light generated by the backlight.

In one arrangement the ratio of the blue light emitting diodes to the red light emitting diodes is substantially two-to-one. Preferably, the phosphor is over coated on a light emitting surface of the at least one blue light emitting diode. Alternatively, the phosphor can be embedded in a matrix with the at least one blue light emitting diode.

In one embodiment two blue light emitting diodes and one red light emitting diode are contained within an individual package. Alternatively, each of the light emitting diodes of the source can be individually packaged. In a further arrangement two blue light emitting diodes are contained within an individual package and a red light emitting diode is contained within an individual package.

Preferably, the blue and red light emitting diodes are operated at a power level ranging from about 20 mA to 350 mA.

The phosphor material can comprise a silicate-based green phosphor; an aluminate-based green phosphor; a nitride-based green phosphor; a sulfate-based green phosphor; an oxy-nitride-based green phosphor; an oxy-sulfate-based green phosphor; a garnet material; a silicate-based green phosphor of a general composition A₃Si(OD)₅ in which Si is silicon, O is oxygen, A comprises strontium (Sr), barium (Ba), magnesium (Mg) or calcium (Ca) and D comprises chlorine (Cl), fluorine (F), nitrogen (N) or sulfur (S); a silicate-based green phosphor of a general composition A₂Si(OD)₄ in which A comprises Sr, Ba, Mg or Ca and D comprises Cl, F, N or S; or a aluminate-based green phosphor of formula M₁₋ₓEuₓAl_{y}O_{[1+3y/2]} in which M is at least one of a divalent metal comprising Ba, Sr, Ca, Mg, Mn, Zn, Cu, Cd, Sm or thulium (Tm).

According to a further aspect of the invention a liquid crystal display backlight comprises: at least one blue LED for contributing blue light to white light generate by the backlight; a first phosphor material which absorbs a portion of the blue light and emits green light which contributes to the white light generated by the backlight; and a second phosphor material which absorbs a portion of the blue light and emits red light which contributes to the white light generated by the backlight.

According to a yet further aspect of the invention there is provided a color liquid crystal display incorporating a backlight according to embodiments of the invention.

### BRIEF DESCRIPTION OF THE DRAWINGS

In order that the present invention is better understood embodiments of the invention will now be described, by way of example only, with reference to the accompanying drawings in which:

FIG. 1 is a schematic representation of a typical color transmissive liquid crystal display as previously described;

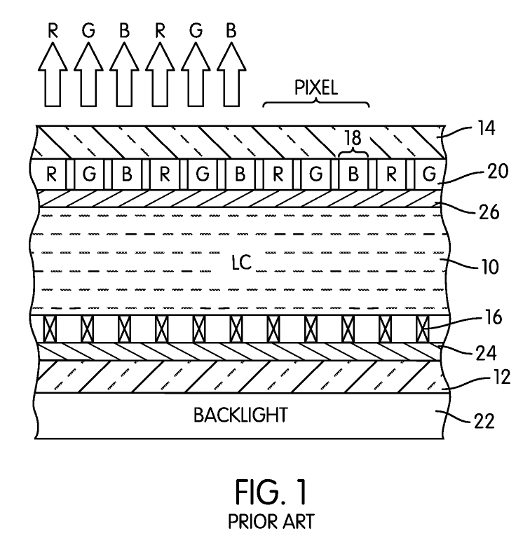

FIGS. 2a to 2c show emission spectra (light intensity versus wavelength) for backlighting systems based on (a) cold cathode fluorescent lamps (CCFLs), (b) blue LED chips exciting phosphors (white LED), and (c) red green and blue (RGB) LEDs as previously described;

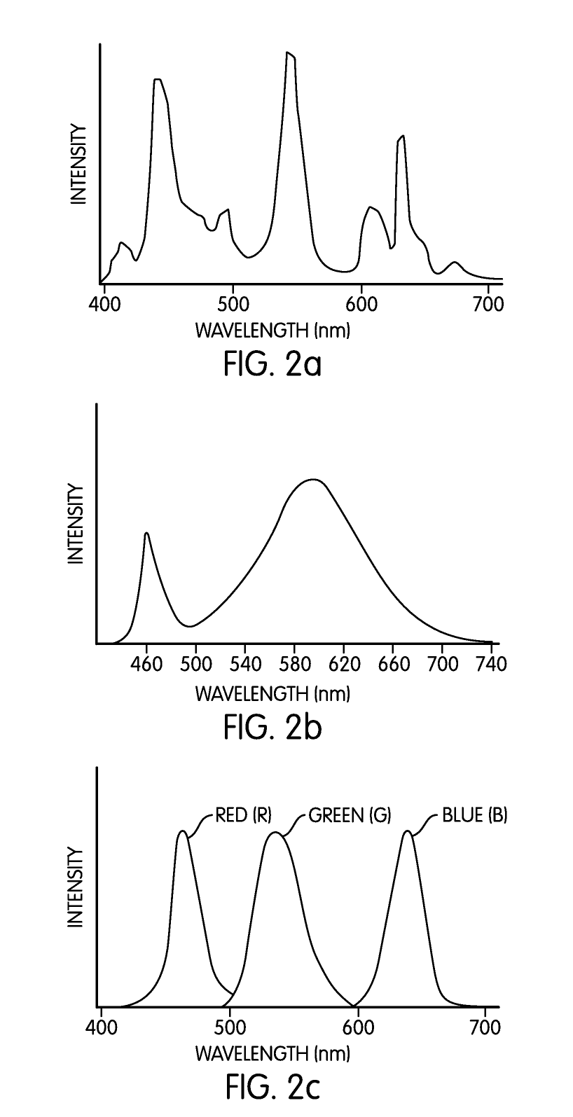

FIG. 3 is a CIE (Commission Internationale de l'Eclairage) 1931 chromaticity diagram illustrating the NTSC (National Television Standards Committee) color space specification and typical color space for backlighting systems based on (a) cold cathode fluorescent lamps (CCFLs), (b) white LED (c) RGB LEDs as previously described;

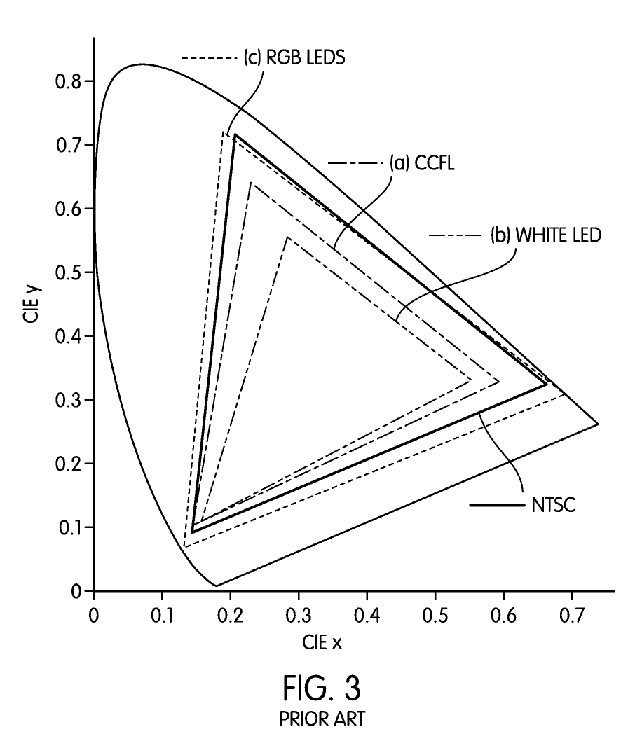

FIG. 4 is a perspective illustration of a liquid crystal display backlight light source according to the invention;

FIG. 5 is a typical emission spectrum for the backlight of FIG. 4;

FIG. 6 is a CIE 1931 chromaticity diagram illustrating the NTSC color space specification and color space for backlight of the FIG. 4; and

FIGS. 7a to 7f are schematic representations of backlight arrangements in accordance with further embodiments of the invention.

### DETAILED DESCRIPTION OF THE INVENTION

Embodiments of the invention are directed to LCD backlight units (BLU) using combinations of a blue LED and green emitting phosphors, to achieve a color performance between that of white LED and RGB LED based backlights. The color performance is comparable to that of a CCFL-based design, but without the complicated design features of the CCFL.

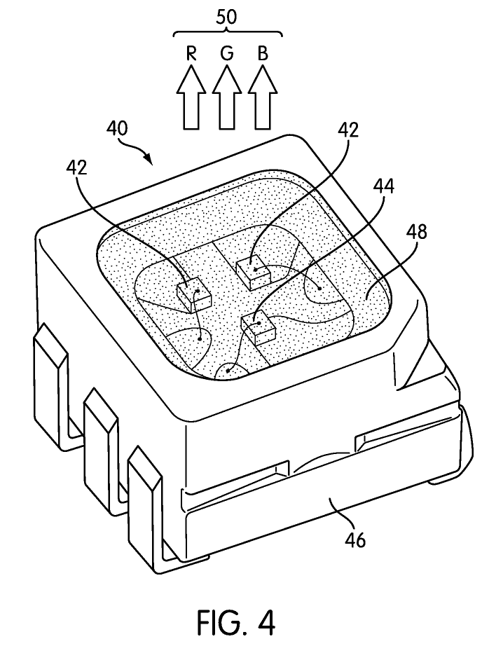

A color LCD backlight light source 40 in accordance with the invention is illustrated in FIG. 4. The backlight light source 40 comprises two blue LED chips 42, such as for example InGaN/GaN (indium gallium nitride/gallium nitride) based LED chips, which generate blue light of wavelength 400 to 465 nm and one red LED chip 44. The blue and red LED chips 42, 44 are co-packaged in a single lead-frame 46 and each is covered by a green phosphor 48 (indicated by a cross hatching of dashed lines). The phosphor material, which is in powdered form, can be mixed with a suitable transparent binder material such as a silicone material and the LED chips then encapsulated with the phosphor mixture. An example of a suitable silicone material is GE's silicone RTV615. The weight ratio loading of phosphors to silicone depends on the required target color of the device.

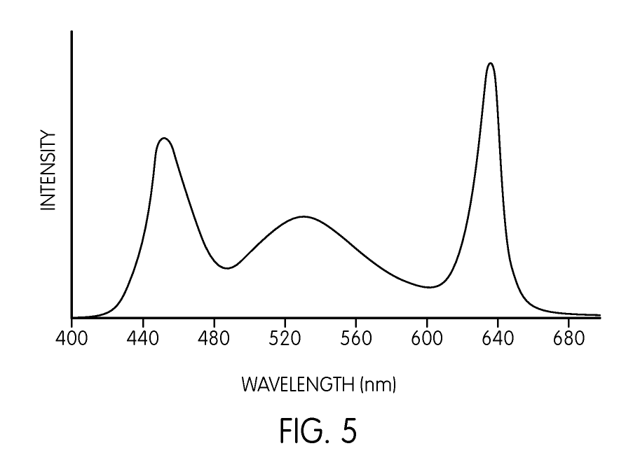

An illustrative emission spectrum from such a device 40 is presented in FIG. 5. In operation, each blue LED chip 42 generates blue light (B) a portion of which is absorbed by the green phosphor causing a photoluminescence of the phosphor material which emits green light (G) that contributes to white light 50 generated by the source 40. By changing the concentration, quantity, and chemical composition of the green phosphor, both the intensity and wavelength of the green emission can be controlled. The green light (G) emitted by the green phosphor, the red light (R) emitted by the red LED 44, and the residual blue LED light (B) (i.e., the remaining blue light from the blue LED not absorbed by the phosphor) are combined to generate the white light 50 shown in the spectrum of FIG. 5. This approach to generating white light for BLUs is defined herein as a “RBB-P backlight”. Although the phosphor 48 will not be excited by the red light and the former may cause scattering and loss of red light, it is preferred for ease of fabrication to provide phosphor material over all three of the LED chips.

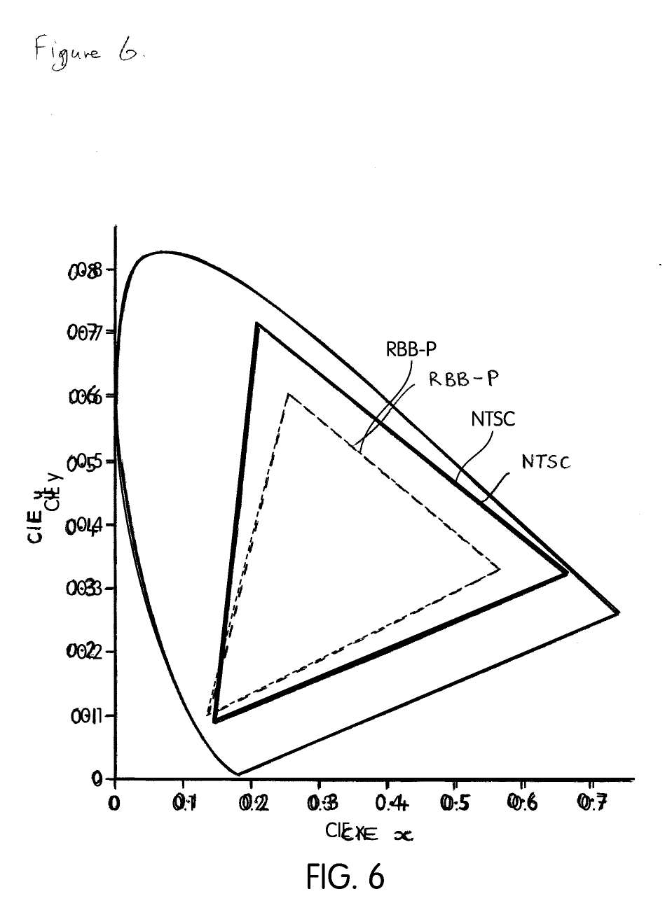

As represented in FIG. 6, RBB-P generated white light can achieve a color performance that is typically about 60% of the NTSC value. In the RBB-P design, the blue and green emission ratio is substantially constant regardless of the amount of electrical current applied to the blue LED chips, and thus the only variable in the device is the emission of the red LED. However, the emission of the red LED chip 44 may be controlled by a feedback system in the same manner as an RGB LED backlighting system.

The phosphor material 48 can comprise any photo-luminescent material which is capable of being excited by the blue light such as for example, silicate, ortho-silicate, nitride, oxy-nitride, sulfate, oxy-sulfate or aluminate-based phosphor materials. In preferred embodiments the phosphor material is a silicate-based phosphor of a general composition A₃Si(OD)₅ or A₂Si(OD)₄ in which Si is silicon, O is oxygen, A comprises strontium (Sr), barium (Ba), magnesium (Mg) or calcium (Ca) and D comprises chlorine (Cl), fluorine (F), nitrogen (N) or sulfur (S). Examples of silicate-based phosphors are disclosed in our co-pending patent applications US2006/0145123, US2006/028122 and US2006/261309 the content of each of which is hereby incorporated by way of reference thereto.

As taught in US2006/0145123, a europium (Eu²⁺) activated silicate-based green phosphor has the general formula (Sr,A₁)ₓ(Si,A₂)(O,A₃)₂₊ₓ:Eu²⁺ in which: A₁ is at least one of a 2+ cation, a combination of 1+ and 3+ cations such as for example Mg, Ca, Ba, zinc (Zn), sodium (Na), lithium (Li), bismuth (Bi), yttrium (Y) or cerium (Ce); A₂ is a 3+, 4+ or 5+ cation such as for example boron (B), aluminum (Al), gallium (Ga), carbon (C), germanium (Ge), N or phosphorus (P); and A₃ is a 1-, 2- or 3-anion such as for example F, Cl, bromine (Br), N or S. The formula is written to indicate that the A₁ cation replaces Sr; the A₂ cation replaces Si and the A₃ anion replaces O. The value of x is an integer or non-integer between 2.5 and 3.5.

US2006/028122 discloses a silicate-based yellow-green phosphor having a formula A₂SiO₄:Eu²⁺D, where A is at least one of a divalent metal comprising Sr, Ca, Ba, Mg, Zn or cadmium (Cd); and D is a dopant comprising F, Cl, Br, iodine (I), P, S and N. The dopant D can be present in the phosphor in an amount ranging from about 0.01 to 20 mole percent. The phosphor can comprise (Sr_{1-x-y}BaₓM_{y})SiO₄:Eu²⁺F in which M comprises Ca, Mg, Zn or Cd.

US2006/261309 teaches a two phase silicate-based phosphor having a first phase with a crystal structure substantially the same as that of (M1)₂SiO₄; and a second phase with a crystal structure substantially the same as that of (M2)₃SiO₅ in which M1 and M2 each comprise Sr, Ba, Mg, Ca or Zn. At least one phase is activated with divalent europium (Eu²⁺) and at least one of the phases contains a dopant D comprising F, Cl, Br, S or N. It is believed that at least some of the dopant atoms are located on oxygen atom lattice sites of the host silicate crystal.

The phosphor can also comprise an aluminate-based material such as is taught in our co-pending patent application US2006/0158090, the content of which is hereby incorporated by way of reference thereto, which teaches an aluminate-based green phosphor of formula M₁₋ₓEuₓAl_{y}O_{[1+3y/2]} in which M is at least one of a divalent metal comprising Ba, Sr, Ca, Mg, Mn, Zn, Cu, Cd, Sm and thulium (Tm) and in which 0.1≦x≦0.9 and 0.5≦y≦2.

It will be appreciated that the phosphor is not limited to the examples described herein and can comprise any inorganic blue activated phosphor material including for example nitride and sulfate phosphor materials, oxy-nitrides and oxy-sulfate phosphors or garnet materials.

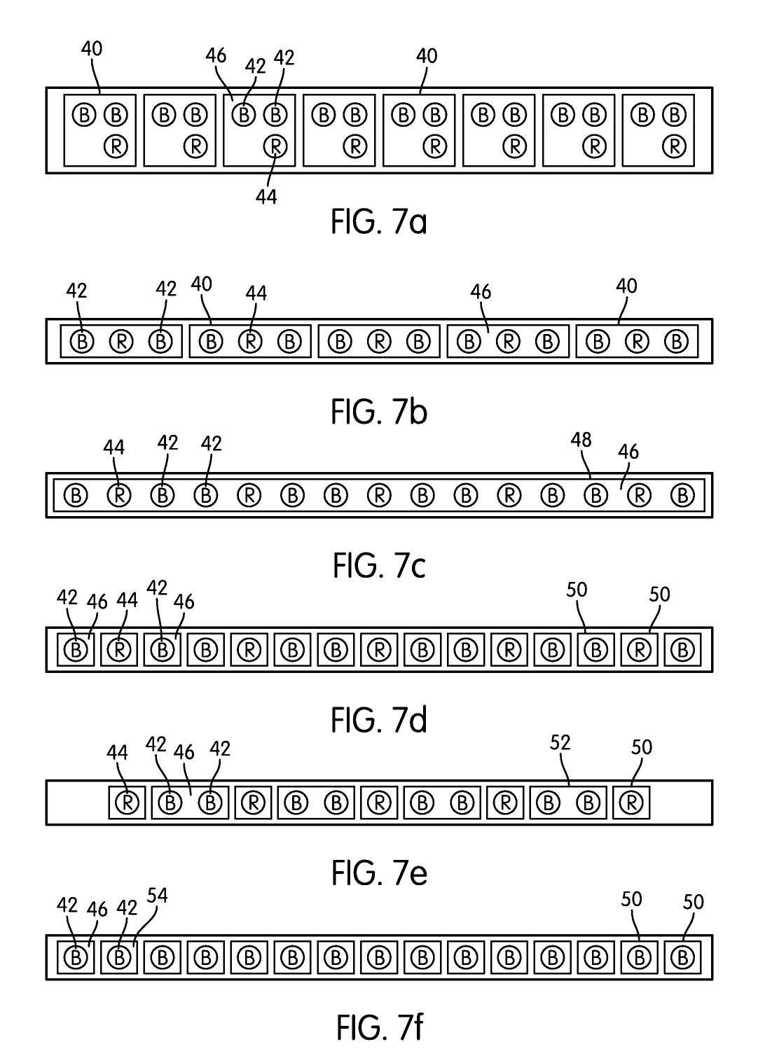

There are a variety of ways in which the components of the RBB-P system can be configured and the designs shown in FIGS. 7a to 7e are illustrative of only some of the designs contemplated. For example, three LED chips (two blue 42 and one red 44) can be packaged together, all of the LED chips of the BLU can be packaged together, or each of the LED chips can be packaged separately (individually).

In one embodiment of the present invention, two blue LED chips and one red LED chip are packaged in a single package 40, in which the two blue LED chips 42 occupy a first row; and the single red LED chip 44 occupies a second row, as viewed from the top, looking down on the package. The position of the red LED chip can be such that it forms an equilateral triangle with the two blue LED chips (again in a top view), as shown in the example of FIG. 4. Alternatively, the red LED chip 44 can be positioned in its row with a vacancy in the row, such that one blue LED chip 42 and the vacancy align in a column, and the second blue LED chip 42 and the red LED chip 44 align to form another column. This is the design shown in FIG. 7a.

Obviously, there are a large number of possible ways to arrange the two blue LED chips and the one red LED chip in a single package, a so-called “3-in-1” package 40. Apart from triangles and squares as seen from a top view (with a vacancy as one of the members of the square), the three LEDs may be arranged linearly; i.e. in a series. This configuration provides a slim, rectangular shaped device which may be encapsulated with a green phosphor deposited on the light emitting top surfaces of the chips, as shown in FIG. 7b. A series of this type of package may be constructed to serve as “light bars” in BLUs.

In an alternative embodiment, an array of LED chips may be arranged in a configuration where the ratio of blue LED chips to red LED chips is still two-to-one, but where the LED chips are packaged in groups of three; rather, all the chips are packaged in a series in a single package 48 having the desired length. This “long bar package” will also have a slim, rectangular shape when viewed from the side, as illustrated in FIG. 7c, and may be square or rectangular shaped when viewed from the top. As with previous designs, all the LED chips are encapsulated with a green emitting phosphor.

In an alternative embodiment, an array of LED chips can be arranged in a configuration where the ratio of blue LED chips to red LED chips is again two-to-one, this time with each of the LED chips residing in its own individual package 50. A further difference with this configuration is that only the blue LED chips 42 are over coated with the green phosphor; the red LED chips do not have any of the green phosphor deposited onto their top surfaces and/or encapsulated in the red packages. The LED packages may be arranged in series in either a slim rectangular shaped configuration as seen in a side view, or a square/rectangular shaped configuration as seen from a top view (2 in 1). These configurations are illustrated in FIG. 6d. A series of these type of packages may be connected in series with red chips, the resulting device serving as light bars in BLUs.

In an alternative embodiment, a linear configuration may again be constructed, but this time the two blue LED chips 42 together reside in one package 52, and the red LED chip in an individual package 50, thus preserving the two-to-one blue to red ratio. A green phosphor is encapsulated in a matrix in the package 52 with the two blue LED chips, or the two blue LED chips may be over coated with the green phosphor. The packages 50 containing the red LED chips 44 do not contain green phosphor. This configuration is illustrated in FIG. 7e.

In another embodiment of the present invention, there is only one type of LED, the blue LED, and two types of phosphor materials. In this embodiment, a blue LED chip 42 is used to excite a green phosphor 46 to make green light, and a blue LED chip is used to excite a red phosphor 54 to make red light. In keeping with the principles described above, the blue light is derived from the blue LED and is “residual light,” that is to say, blue light that is not absorbed by and used to excite either the green phosphor 46 or the red phosphor 54. In one example, illustrated in FIG. 7f, the ratio of the packages 50 containing green phosphor to red phosphor is two-to-one. Each of the LED chips is individually packaged in FIG. 4f, but this is not a requirement. This configuration may be denoted by the designation B-PP. By adjusting the phosphor composition and/or concentration, white light may be generated. Although the color performance may in some situations be somewhat lower than the performance that can be achieved by a RBB-P design, the configuration of FIG. 7f is very simple in that only one type of LED chip is needed in the design.

### ADVANTAGES OF THE PRESENT EMBODIMENTS

The present embodiments offer significant advantages over prior art RGB LED backlight package designs, in part because with the present design, the light from the green phosphor is emitted dependently with the light from the blue LED chip, and in all cases as part of the same package. That is to say, the green light contribution to the white backlighting system results from a blue LED exciting a green phosphor.

An advantage is that only two types of LED chips, one blue and one red, are needed to achieve white light CIE target specifications. This is because of the high brightness of the blue LED chips that are currently available, as well as the high efficiency of the green phosphors available for converting blue light to green light. This is to be contrasted with the prior art RGB LED backlight systems, where normally three types of LED chips are needed (one red, one blue, one green), these three types of chips typically being utilized in an RGGB configuration. The ratios are such that two green LEDs are needed per one red and one blue LED in prior art RGB LED backlight systems to achieve white light CIE target specifications.

The present embodiments significantly simplify the driver circuit of a BLU because only two independent drivers are needed (for the blue and red LED chips, respectively), while three independent drivers are needed for a typical prior art RGB LED configuration. Additionally, the present embodiments simplify the required feedback loop of a BLU. Only one sensor feedback is needed, for the red LED chip.

In all of the above embodiments, either low-power LEDs operating at 20 mA, high-power LEDs operating at 350 mA, or other LEDs with a power in between 20 mA and 350 mA, or greater than 350 mA may be used. Furthermore, the BLUs may be lit by either placing the light bar at the edge, or forming a planar matrix as a planar light source.

1. A liquid crystal display backlight comprising:
at least one blue light emitting diode operable to contribute blue light to white light generated by the backlight;
a phosphor material which absorbs a portion of the blue light and emits green light which contributes to the white light generated by the backlight; and
at least one red light emitting diode operable to contribute red light to the white light generated by the backlight.

2. The backlight according to claim 1, wherein the ratio of the blue light emitting diodes to the red light emitting diodes is substantially two-to-one.

3. The backlight according to claim 1, wherein the phosphor material is over coated on a light emitting surface of the at least one blue light emitting diode.

4. The backlight according to claim 1, wherein the phosphor material is embedded in a matrix with the at least one blue light emitting diode.

5. The backlight according to claim 1, wherein two blue light emitting diodes and one red light emitting diode are contained within an individual package.

6. The backlight according to claim 1, wherein each of the light emitting diodes of the source is individually packaged.

7. The backlight according to claim 1, wherein two of the at least one blue light emitting diodes are contained within an individual package, and one of the at least one red light emitting diodes is contained within an individual package.

8. The backlight according to claim 1, wherein the at least one blue light emitting diode operates at a power level ranging from about 20 mA to 350 mA.

9. The backlight according to claim 1, wherein the at least one red light emitting diode operates at a power level ranging from about 20 mA to 350 mA.

10. The backlight according to claim 1, wherein the phosphor material is selected from the group consisting of: a silicate-based green phosphor; an aluminate-based green phosphor; a nitride-based green phosphor; a sulfate-based green phosphor; an oxy-nitride-based green phosphor; an oxy-sulfate-based green phosphor; a garnet material; a silicate-based green phosphor of a general composition A₃Si(OD)₅ in which Si is silicon, O is oxygen, A comprises strontium (Sr), barium (Ba), magnesium (Mg) or calcium (Ca) and D comprises chlorine (Cl), fluorine (F), nitrogen (N) or sulfur (S); a silicate-based green phosphor of a general composition A₂Si(OD)₄ in which A comprises Sr, Ba, Mg or Ca and D comprises Cl, F, N or S; and an aluminate-based green phosphor of formula M₁₋ₓEuₓAl_{y}O_{[1+3y/2]} in which M is at least one of a divalent metal comprising Ba, Sr, Ca, Mg, Mn, Zn, Cu, Cd, Sm or thulium (Tm).

11. A color liquid crystal display incorporating a backlight according to claim 1.

12. A liquid crystal display backlight comprising:
at least one blue LED for contributing blue light to white light generate by the backlight;
a first phosphor material which absorbs a portion of the blue light and emits green light which contributes to the white light generated by the backlight; and
a second phosphor material which absorbs a portion of the blue light and emits red light which contributes to the white light generated by the backlight.

13. The backlight according to claim 12, wherein the at least one blue LED operates at a power level ranging from about 20 mA to 350 mA.

14. The backlight according to claim 12, wherein the phosphor material is selected from the group consisting of: a silicate-based phosphor; an aluminate-based phosphor; a nitride-based phosphor; a sulfate-based phosphor; an oxy-nitride-based phosphor; an oxy-sulfate-based phosphor; a garnet material; a silicate-based phosphor of a general composition A₃Si(OD)₅ in which Si is silicon, O is oxygen, A comprises strontium (Sr), barium (Ba), magnesium (Mg) or calcium (Ca) and D comprises chlorine (Cl), fluorine (F), nitrogen (N) or sulfur (S); a silicate-based phosphor of a general composition A₂Si(OD)₄ in which A comprises Sr, Ba, Mg or Ca and D comprises Cl, F, N or S; and an aluminate-based phosphor of formula M₁₋ₓEuₓAl_{y}O_{[1+3y/2]} in which M is at least one of a divalent metal comprising Ba, Sr, Ca, Mg, Mn, Zn, Cu, Cd, Sm or thulium (Tm).

15. A color liquid crystal display incorporating a backlight according to claim 12.

16. A white light source comprising:
at least one blue light emitting diode operable to contribute blue light to white light generated by the source;
a phosphor material which absorbs a portion of the blue light and emits green light which contributes to the white light generated by the source; and
at least one red light emitting diode operable to contribute red light to the white light generated by the source.

17. The light source according to claim 16, wherein the ratio of the blue light emitting diodes to the red light emitting diodes is substantially two-to-one.

18. The light source according to claim 16, wherein the phosphor material is over coated on a light emitting surface of the at least one blue light emitting diode.

19. The light source according to claim 16, wherein the phosphor material is embedded in a matrix with the at least one blue light emitting diode.

20. The light source according to claim 16, wherein two blue light emitting diodes and one red light emitting diode are contained within an individual package.

21. The light source according to claim 16, wherein the phosphor material is selected from the group consisting of: a silicate-based green phosphor; an aluminate-based green phosphor; a nitride-based green phosphor; a sulfate-based green phosphor; an oxy-nitride-based green phosphor; an oxy-sulfate-based green phosphor; a garnet material; a silicate-based green phosphor of a general composition A₃Si(OD)₅ in which Si is silicon, O is oxygen, A comrises strontium (Sr), barium (Ba), magnesium (Mg) or calcium (Ca) and D comprises chlorine (Cl), fluorine (F), nitrogen (N) or sulfur (S); a silicate-based green phosphor of a general composition A₂Si(OD)₄ in which A comprises Sr, Ba, Mg or Ca and D comprises Cl, F, N or S; and an aluminate-based green phosphor of formula M₁₋ₓEuₓAl_{y}O_{[1-3y/2]} in which M is at least one of a divalent metal comprising Ba, Sr, Ca, Mg, Mn, Zn, Cu, Cd, Sm or thulium (Tm).
